(19) United States
(12) Patent Application Publication
(10) Pub. No.: US 2009/0249971 A1
(43) Pub. Date: Oct. 8, 2009

(54) Printing machine and method for its calibration

(75) Inventors: Angelo Benvenuti, Lucca (IT); David Lencioni, Massarosa (IT)

Correspondence Address: BREINER & BREINER, L.L.C., P.O. BOX 320160, ALEXANDRIA, VA, 22320-0160, US

(73) Assignee: Fabio Perini S.p.A., Lucca (IT)

(21) Appl. No.: 12/385,276

(22) Filed: Apr. 3, 2009

(30) Foreign Application Priority Data
Apr. 4, 2008 (IT) FI2008A000064

(51) Int. Cl. B41F 9/00

(52) U.S. Cl. 101/153

(57) ABSTRACT

The printing machine comprises a central roller (3); at least one printing unit (5) with a cliché roller (7) and means (9, 13) for applying ink to the cliché roller. A control unit (50) in also provided, interfaced with at least one actuator (19) to move the printing unit towards the central roller. The printing unit (5) comprises at least one load sensor (41) and at least one position transducer (43) associated with the cliché roller, interfaced with the control unit. This latter is programmed to perform a calibration of the printing unit with a first step to move the printing unit towards the central roller until reaching a zero position defined on the basis of a signal of said at least one load sensor.

### TECHNICAL FIELD

The present invention relates to a printing machine and in particular to a color-printing machine with devices for its calibration, i.e. for positioning of the printing units with respect to a central drum or roller.

### STATE OF THE ART

Printing machines comprise a central drum or roller around which the web material to be printed is fed. Printing units, in the same number as the number of colors used, are arranged in various angular positions around the central drum or roller. The printing units each comprise a cliché roller, which receives ink from an application or distribution system and transfers it to the web material to be printed. In general, the ink is distributed on the cliché roller by means of an anilox roller, which in turn receives it from an ink dispenser, which can have various configurations. The cliché roller has a raised pattern, which receives the ink and transfers it to produce a corresponding printed pattern on the web material. For correct printing it is necessary to position the cliché roller precisely with respect to the central roller so that there is complete contact at the correct pressure between the web material to be printed and the surface of the selected roller. Similar adjustments are often required to adjust the position of the anilox roller with respect to the cliché roller.

Various calibration or adjustment systems are used for this purpose, which allow identification of the initial position of the printing unit with respect to the central drum or roller and retrieval of this position each time a machine is operated by moving the printing units towards the central roller. This calibration method and the relative devices present on currently known machines are not satisfactory, as they require long and complex operations with a considerable amount of manpower.

In particular, in known machines a system is typically used to move the cliché roller towards the central roller with interposition of a known feeler gauge, typically of one tenth of millimeter, interposed between the cliché roller and the central roller. This movement is performed manually operating each of the two motors or actuators with which each cliché roller is equipped at its ends. In a four-color machine this means making eight adjustments. Similar adjustments are required for the anilox roller of each printing unit, also by means of two respective actuators for a total of sixteen manual adjustments. The position taken by each roller through manual positioning and use of the aforesaid feeler gauge is stored and subsequently used to return the printing unit to its correct position.

These adjustments are performed with the cliché roller not fitted with the outer sleeve, which carries the respective pattern to be printed. When the machine must be operated after the initial calibration step and with the sleeves fitted on the single cliché rollers, positioning is performed taking into account the thickness of each sleeve fitted on each cliché roller and therefore taking the cliché rollers and respective anilox rollers to the calibration position previously identified with the manual operations described above, minus the thickness of the sleeve.

### SUMMARY OF THE INVENTION

According to one aspect the invention provides a machine, which allows a simpler, more precise and/or more rapid calibration with respect to what is can currently be achieved with prior art machines.

In substance, the invention relates to a printing machine comprising: a central roller; at least one printing unit with a cliché roller and means for applying an ink to said cliché roller, said cliché roller cooperating with said central roller; a control unit interfaced with at least one actuator to move the printing unit towards the central roller. Advantageously, the printing unit comprises at least one load sensor and at least one position transducer associated with the cliché roller, interfaced with the control unit. Moreover, the control unit can be programmed to perform a calibration of the printing unit with a first step to move the printing unit towards the central roller until reaching a zero position defined on the basis of a signal of said at least one load sensor. In this manner, the subsequent operations to move the printing unit towards the central roller are performed using said at least one position transducer and said zero position. With a device of this type initial calibration takes place simply by setting the value that the load sensor must detect when the cliché roller has reached its zero position. This position is then stored and retrieved each time the machine is brought into operation by means of the position transducer. Load sensor is intended in general as a sensor capable of detecting a force or a pressure, and which therefore allows identification of the zero position of the cliché roller through a value which is a function of the stress exerted on the roller by the constraints with which it is supported and therefore, in substance, which allows the pressure between the cliché roller and the central roller to be measured.

A sensor of this type can typically be a load cell which, for example, detects a load on a bearing, or a pressure sensor inside a hydraulic actuator which moves the cliché roller with respect to the central roller.

Further advantageous features and embodiments of the invention are indicated in the dependent claims and will be described hereunder with reference to the drawing, which shows a non-limiting embodiment of the invention.

### BRIEF DESCRIPTION OF THE DRAWINGS

The invention will be better understood by following the description and accompanying drawing, which shows a non-limiting practical embodiment of the invention. More in particular, in the drawing:

FIG. 1 shows a schematic side view of a four-color printing machine;

FIG. 2 shows an enlarged side view of one of the printing units of the machine of FIG. 1; and

FIG. 3 shows a section according to III-III of FIG. 2;

### DETAILED DESCRIPTION OF AN EMBODIMENT OF THE INVENTION

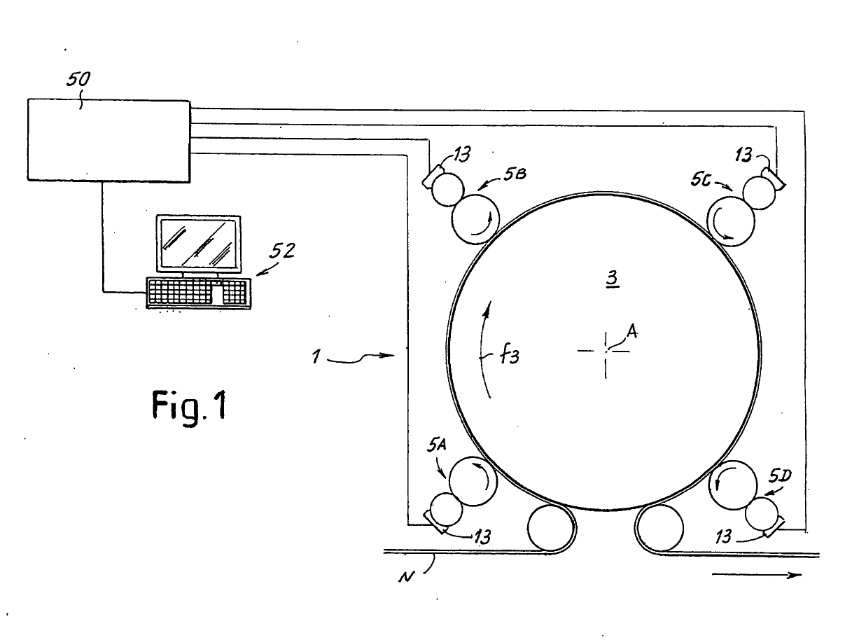

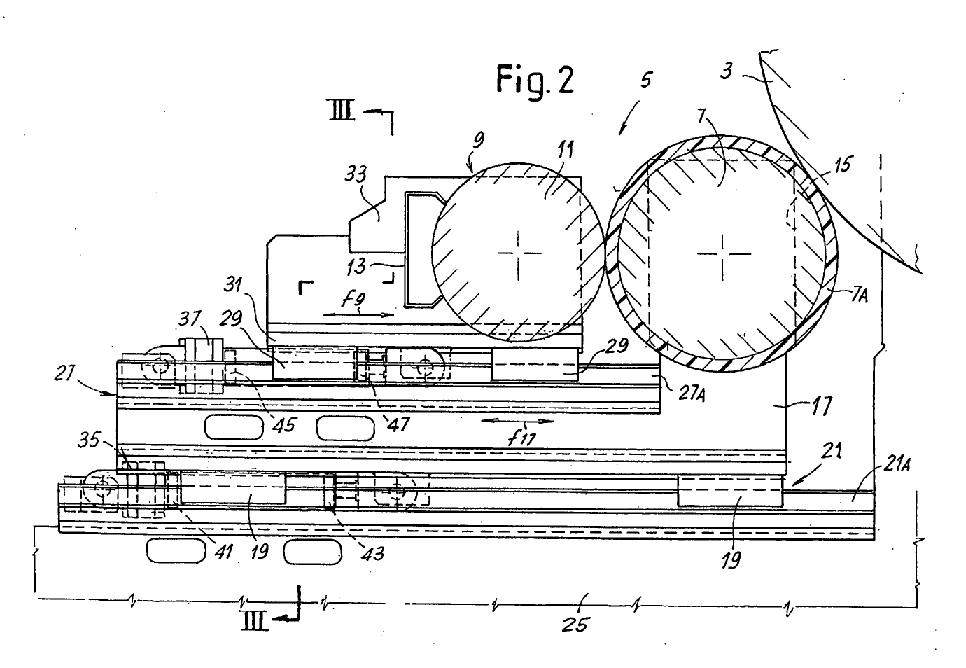

The present invention can be applied to printing machines with a variable number of printing units. The example (FIG. 1) shows a machine, indicated as whole with 1, which prints in four colors. In this embodiment the machine has a central roller, barrel or drum 3, rotating about its axis A according to the arrow f3 and around which the web material to be printed, for example a paper web, is fed. Four printing units, indicated with 5A, 5B, 5C and 5D respectively, are positioned around the axis A of the central roller 3. The four printing units 5A-5D have substantially the same structure one of which, generically indicated with 5, is represented in detail in FIG. 2.

The printing unit 5 of FIG. 2 comprises a cliché roller 7 cooperating with the central roller 3 and equipped or equippable a sleeve 7A on which the pattern to be printed is produced in relief. The means for applying ink to the cliché roller 7 are indicated with the numeral 9. In some embodiments the means 9 comprise an anilox roller 11, which receives ink from a dispenser 13.

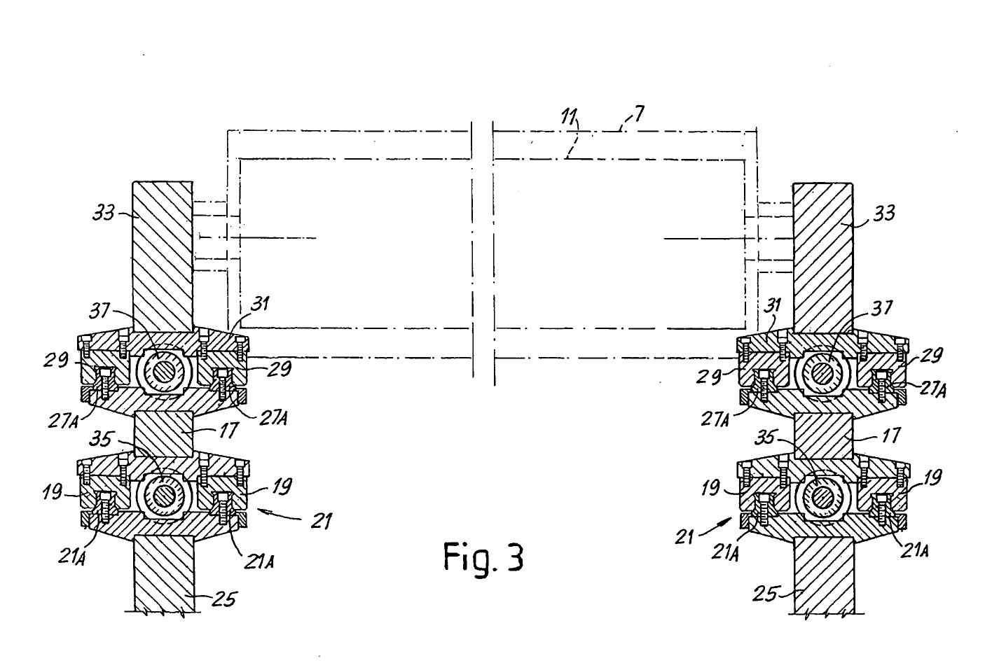

The cliché roller 7 is carried by side panels 15 mounted on respective slides 17 guided by sliding blocks 19 on a pair of guide systems 21 positioned at the sides of the machine. The section of FIG. 3 schematically shows one of the guide units 21 which, in the example shown, comprises two guides 21A carried by the fixed structure 25 of the printing unit and in which sliding blocks 19 engage.

Each slide 17 is provided with second guide systems 27, engaging in which are sliding blocks 29 constrained to further slides 31, which carry side panels 33 to support the anilox roller 11. The section of FIG. 3 shows a possible embodiment of the guide and sliding system of the slides 31 with respect to the slides 17, with a pair of guides 27A on which the sliding blocks 29 of the slides 31 engage.

In some embodiments movement of the slides 17 according to the double arrow f17 towards and away from the central roller 3, and therefore movement of the entire printing unit 5 towards and away from the central roller, is controlled by a pair of hydraulic piston-cylinder actuators 35. The latter are engaged at one end to the fixed structure 25 and at the opposite end to the slides 17. With a similar arrangement, it is possible to obtain movement of the unit carrying the anilox roller 11 according to the double arrow f9 towards and away from the cliché roller 7. In this case, two hydraulic piston-cylinder actuators 37 are provided, each constrained at one end to the respective slide 17 and at the opposite end to the respective slide 31.

To perform calibration and correct positioning of each printing unit 5 each time the machine is operated, for example after having replaced the sleeve 7A of one or more cliché rollers 7, load sensors and position transducers are associated with the various actuators associated with the single printing units 5, 5A-5D. More in particular, according to some embodiments, a load sensor and a position transducer are associated with each of the actuators 35, 37. In the drawing, these members are represented schematically with 41 and 43 for the hydraulic piston-cylinder actuators 35 and with 45 and 47 for the hydraulic piston-cylinder actuators 37. In some embodiments the load sensor can be formed of a load cell positioned inside the chamber of each hydraulic piston-cylinder actuator to detect the pressure of the hydraulic liquid inside. In other embodiments the load sensor can instead be positioned on the support of each bearing of the respective rollers 7 and 11. What is important is that the load sensor detects a measurement linked to the stresses exerted on the respective cliché roller 7 or on the anilox roller 11 respectively. In a preferred modified embodiment, the load sensor can be formed of a pressure switch, installed on the piping connected to the piston-cylinder actuators, or directly on the bottom of these cylinders.

Similarly, the position transducer can be of different type and can be incorporated inside the piston cylinder actuator 35 or 37, or can be fitted on the fixed part or on the moving part of the relative support system of the roller 7 or of the roller 11. What is important is only to detect the position of a member constrained to the respective cliché roller 7 or anilox roller 1 to allow correct and precise identification of its position with respect to the fixed structure 25, in the case of the cliché roller 7, or with respect to the fixed structure 25 or with respect to the slide 17 in the case of the roller 11.

In the configuration shown sixteen piston-cylinder actuators are therefore provided, two for each cliché roller 7 and two for each anilox roller 11, with respective sixteen position transducers and sixteen load transducers or load sensors. These members are connected to a central control unit schematically shown at 50 (FIG. 1), which receives data from the sensors and transducers and sends commands to the actuators.

The machine described above can perform a calibration cycle according to the method described below. Normally, calibration is performed with the cliché roller 7 not fitted with the sleeve 7A, as sleeves 7A can vary in thickness and the calibration step is instead performed to identify a zero position for subsequent positioning of the rollers, which will take account of the dimensions of the sleeves 7A inserted or fitted on the cliché rollers 7 each time.

In a first calibration step, the slides 17 of the single printing unit 5 are moved towards the central roller 3 carrying the cliché roller 7 not fitted with a sleeve 7A to press against this central roller. The load transducers or load sensors 41 detect a signal proportional to the pressure with which the cliché rollers 7 are pressed against the central roller 3. A contact pressure at which the slides 17 are stopped is set using an appropriate user interface 52. The position reached by each of the slides 17, detected by the position transducers 43 associated with the actuators 35, is stored as zero position.

A similar procedure can be performed for each of the cliché rollers 11 using the actuators 37 for movement of these rollers and identifying the zero position through the pressure or load sensors 54 and storing the zero position with the position transducers 47.

As each roller 7, 9 is carried by a pair of slides 17, 31, in this manner it is possible to correctly position each roller acting independently on the two ends thereof.

After storing the zero position of each cliché roller 7 and of each anilox roller 11 in this manner, it is possible to rapidly return the machine to the correct operating position each time it has been stopped and must be restarted, for example after having replaced the sleeves 7A on the cliché rollers 7. It will be sufficient to command, through the control unit 50 using the interface 52, movement of the cliché rollers 7 and of the anilox rollers 11 to operating positions which are determined on the basis of the zero position set with the calibration cycle described above and modified with the thickness values of the sleeve 7A inserted on the cliché roller 7 each time, said thickness being known to the operator and communicated to the control unit 50 using the interface 52.

It is understood that the drawing shows just one example, provided merely as a practical demonstration of the invention, which can vary in its forms and arrangements, without however departing from the scope of the concept underlying the invention. Any reference numbers in the appended claims are provided to facilitate reading of the claims with reference to the description and to the drawing, and do not limit the scope of protection represented by the claims.

1. A printing machine comprising:
a central roller;
at least one printing unit with a cliché roller and means for applying an ink to said cliché roller, said cliché roller cooperating with said central roller;
a control unit interfaced with at least one actuator to move the at least one printing unit towards the central roller;
wherein a printing unit of said at least one printing unit comprises at least one load sensor and at least one position transducer associated with said cliché roller, interfaced with said control unit; and wherein said control unit is programmed to perform a calibration of the printing unit with a first step to move the printing unit towards the central roller until reaching a zero position defined on a basis of a signal of said at least one load sensor, subsequent operations to move the printing unit towards the central roller being performed using said at least one position transducer and said zero position.

2. The machine as claimed in claim 1, further comprising a pair of actuators for the cliché roller, associated at two ends of said cliché roller, each of said pair of actuators being associated with a respective one of said at least one position transducer and with a respective one of said at least one load sensor, said zero position being determined independently for each actuator of said pair of actuators.

3. The machine as claimed in claim 2, wherein said pair of actuators are hydraulic actuators.

4. The machine as claimed in claim 3, wherein said at least one load sensor is a pressure sensor positioned to measure pressure of operating fluid of said hydraulic actuators.

5. The machine as claimed in claim 2, wherein said cliché roller is mounted on a first pair of slides sliding on first guides carried by a support structure, a respective one of said pair of actuators with a respective one of said position transducer and said respective one of said at least one load sensor being associated respectively with each of said first guides.

6. The machine as claimed in claim 5, wherein second guides for a second pair of slides carrying said means for applying said ink are provided on said second pair of slides carrying the cliché roller.

7. The machine as claimed in claim 6, wherein said second pair of slides is equipped with actuators and transducers to move an ink distributor roller towards the cliché roller, said actuators and said transducers of said second pair of slides being interfaced with said control unit.

8. The machine as claimed in claim 1, wherein said printing unit further comprises at least two load sensors and at least two position transducers, associated with an ink distributor roller cooperating with said cliché roller to apply ink to said cliché roller and interfaced with said control unit, and wherein said control unit is programmed to perform a calibration of the printing unit with a first step to move the ink distributor roller towards the cliché roller until reaching a zero position of the ink distributor roller with respect to the cliché roller, defined on a basis of a signal of a second one of said at least two load sensors, the subsequent operations including moving the distributor roller towards the cliché roller being performed using a second one of said at least two position transducers and said zero position.

9. The machine as claimed in claim 8, further comprising a pair of actuators for the ink distributor roller, associated with two ends of said ink distributor roller, each of said pair of actuators being associated with a respective further position transducer and with a respective further load sensor, said zero position being determined independently for each of said pair of actuators.

10. A method for performing calibration of a printing machine, said printing machine comprising a central roller; at least one printing unit with a cliché roller and means to apply ink to the cliché roller; a control unit interfaced with at least one actuator, including at least one load sensor, to move the at least one printing unit towards the central roller; said method comprising moving the cliché roller towards the central roller through said at least one actuator, detecting a first load signal from the at least one load sensor and defining a zero position of said cliché roller when said load signal has reached a predetermined value; and positioning the cliché roller in an operating position with respect to the central roller using a position transducer with reference to said zero position.

11. The method as claimed in claim 10, further comprising providing two actuators associated with two ends of said cliché roller and moving the cliché roller towards the central roller through said two actuators detecting two load signals, one for each of said two actuators, and defining a zero position of said cliché roller when each of said load signals has reached a predetermined value; and positioning the cliché roller in an operating position with respect to the central roller through respective position transducers associated with said two actuators, with reference to a respective zero position.

12. The method as claimed in claim 10, further comprising moving said means to apply ink towards said cliché roller through at least two actuators, detecting a second load signal and defining a zero position of said means to apply ink with respect to said cliché roller when said second load signal has reached a predetermined value; and positioning the means to apply ink in an operating position with respect to the central roller through at least one second position transducer with reference to said zero position.

13. The method as claimed in claim 12, further comprising providing at least four actuators and moving said means to apply ink towards said cliché roller through said at least four actuators and detecting respective load signals and defining a zero position of said means to apply ink with respect to the cliché roller when said second load signals have reached predetermined values; and positioning the means to apply ink in an operating position with respect to the central roller through said at least one second position transducer with reference to said zero position.
